(19) United States
(12) Patent Application Publication
(10) Pub. No.: US 2007/0283819 A1
(43) Pub. Date: Dec. 13, 2007

(54) GASTRONOMY SECTION FOR A PASSENGER TRANSPORT MEANS

(75) Inventor: Andreas Baatz, Sauensiek (DE)

Correspondence Address: PERMAN & GREEN, 425 POST ROAD, FAIRFIELD, CT, 06824, US

(73) Assignee: AIRBUS DEUTSCHLAND GMBH, Hamburg (DE)

(21) Appl. No.: 11/688,412

(22) Filed: Mar. 20, 2007

(30) Foreign Application Priority Data
Mar. 20, 2006 (DE) 10 2006 013 143.6

(51) Int. Cl. A47J 27/00

(52) U.S. Cl. 99/331

(57) ABSTRACT

The invention relates to a gastronomy section for a transport means for conveying passengers, in particular an aircraft, encompassing at least one preparation element (5) with stowage area for storing and/or presenting preliminary products, at least one working area (7) for preparing intermediate products from the preliminary products, at least one heating unit for preparing meals from the intermediate products, and several seat groups (8) for passengers.

In order to enhance the comfort of passengers during meals and snacks, the at least one heating unit according to the invention represents at least one cooking island (4) accessible to passengers from at least one side, so that the meals can be presented there as a kind of buffet.

### FIELD

The disclosed embodiments relate to a gastronomy section for a transport means for conveying passengers according to the claims, and in particular to a kitchen unit in a seating compartment.

### BACKGROUND

Passengers are usually served beverages and meals on longer flights. To this end, the flight attendants use a special cart to retrieve beverages and snacks or meals, either individually or several at a time, from a kitchen unit on the aircraft, and bring them to where the passenger is seated. Beverages and meals are served there. Some time later, the personnel returns and cleans up again. The disadvantage to this is that serving is time and personnel-intensive. In addition, the passengers are confined to their respective seat, must wait and be in their seats, at least at the time when the personnel want to serve them.

Further, the kitchen unit represents a kind of foreign body in the aircraft: They are not very decorative, take up valuable space and are regarded as a separate unit in the cabin. Therefore, prior art has already advanced various proposals for making kitchen units more decorative or limit the space they require.

For example, US 2001/0050519 discloses a kitchen unit with compartments and covers, counters, a decorative wall and a display cabinet. The covers for compartments consist of a fireproof material, and can be moved in such a way as to open or close the compartment opening. The counter can be collapsed and stowed on the side, as can the decorative wall and display cabinet.

U.S. Pat. No. 6,761,332 discloses a kitchen unit having a first structure, a second structure and a passageway for the personnel between the first and second structure. The kitchen system also encompasses a group of doors belonging to the first structure and second structure to hide the passageway for the personnel away from the passengers when the doors are closed.

In order to limit the space required by kitchen units and their accessories, such as service carts, WO 2005/066022 proposes a cart stowage area with walls having a first partial unit and another lying above it as the carts. An automatic transfer system is used for vertically and horizontally moving the carts to the intended location, wherein the carts are set up either for direct access or so-called FIFO access.

Another problem when serving passengers in their seats is that the passengers only have a little room, so that comfort is excessively impinged during the consumption of meals. Therefore, U.S. Pat. No. 6,209,956 proposes a seat group having a main seat with adjustable back in a fixed casing. The base of the seat group can be designed for conversion into a recliner. A side seat is directly opposite the main seat, helping to convert the main seat into a recliner. The seat groups are staggered in the aircraft.

It would be advantageous to eliminate the aforementioned problems while serving passengers where they are seated, and offer the passengers a higher level of comfort during meals and snacks.

### SUMMARY

The idea underlying the layout of the gastronomy section according to the embodiments has to do with integrating a cooking area in a passenger cabin given an open floor plan, as is also common in home kitchens of a higher standard. As a result, the kitchen unit no longer has to be an economic area hidden from view as best as possible, instead becoming a “fun spot” in the aircraft. In addition, this provides a comfortable kitchen unit for flight passengers without having to reserve additional space in the aircraft for this purpose, and without adding extra weight to the aircraft. Cooking on board is no longer regarded as a separate activity, but becomes part of the flying experience.

The gastronomy section according to the invention for a transport means for conveying passengers, in particular an aircraft, specifically encompasses at least one preparation element with stowage area for storing and/or presenting preliminary products, at least one working area for preparing intermediate products from the preliminary products, at least one heating unit for preparing meals from the intermediate products, and several seat groups for passengers. It is characterized in that the at least one heating unit is comprised of at least one cooking island accessible for passengers from at least one side, so that the meals can be presented there as a kind of buffet.

In particular, one or more of the following features are realized in embodiments of the invention:

Several self-serve compartments are arranged next to and/or under the at least one heating unit;

The several self-serve compartments can be heated, cooled or kept at a prescribed temperature;

The several self-serve compartments have transparent doors;

The several self-serve compartments are accessible from their respective front and rear sides;

The cooking island has a glass ceramic surface with one or more cooking surfaces, wherein each cooking surface encompasses an inductive or halogen heating element;

One closed hood is situated over the cooking island and/or several exhaust vents are arranged at the edge of the cooking island;

The cooking island has a detachable splashguard that extends around the cooking surface, and has a glass wall or Plexiglas wall;

The cooking island has means for holding preparation containers in place, which in particular consist of brackets;

The cooking island is height-adjustable;

The seat groups in the gastronomy section are arranged in an at least 180° semicircle around the cooking island;

Each of the seat groups encompasses at least two seats facing each other, as well as a table between the two seats;

The table can be dismantled and/or lowered into the floor of the gastronomy section;

Each seat of a seat group can be rotated around a vertical axis, so that the seat groups can be configured at a predetermined time.

One advantage to the invention lies in the fact that passenger comfort is enhanced during meal consumption, in addition to which passengers can get up and leave their spots as desired, without having to adjust to the flight attendants. Further, “high class” or “event” gastronomy is enabled, e.g., the guest can prepare a meal even without violating safety regulations on board passenger airlines. In addition, service carts are no longer required for serving passengers, thereby saving on weight.

### BRIEF DESCRIPTION OF THE DRAWINGS

Other features and advantages of the invention may be gleaned from the following description of exemplary embodiments of the invention, wherein reference is made to the attached drawings.

FIG. 1A and 1B show the floor plan of an embodiment of the gastronomy section according to the invention in an aircraft during takeoff or landing, as well as during flight.

FIG. 2 shows a perspective view of a portion of the embodiment of the gastronomy section according to the invention.

FIG. 3 shows an embodiment of the seat group according to the invention from the side.

### DETAILED DESCRIPTION

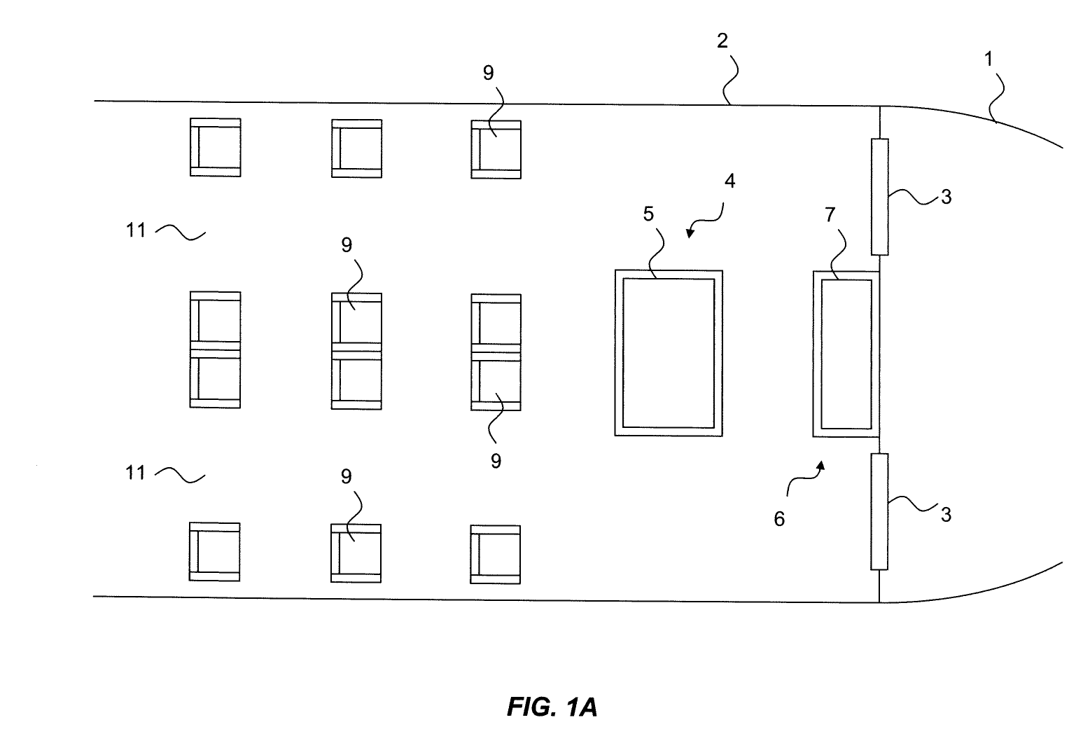

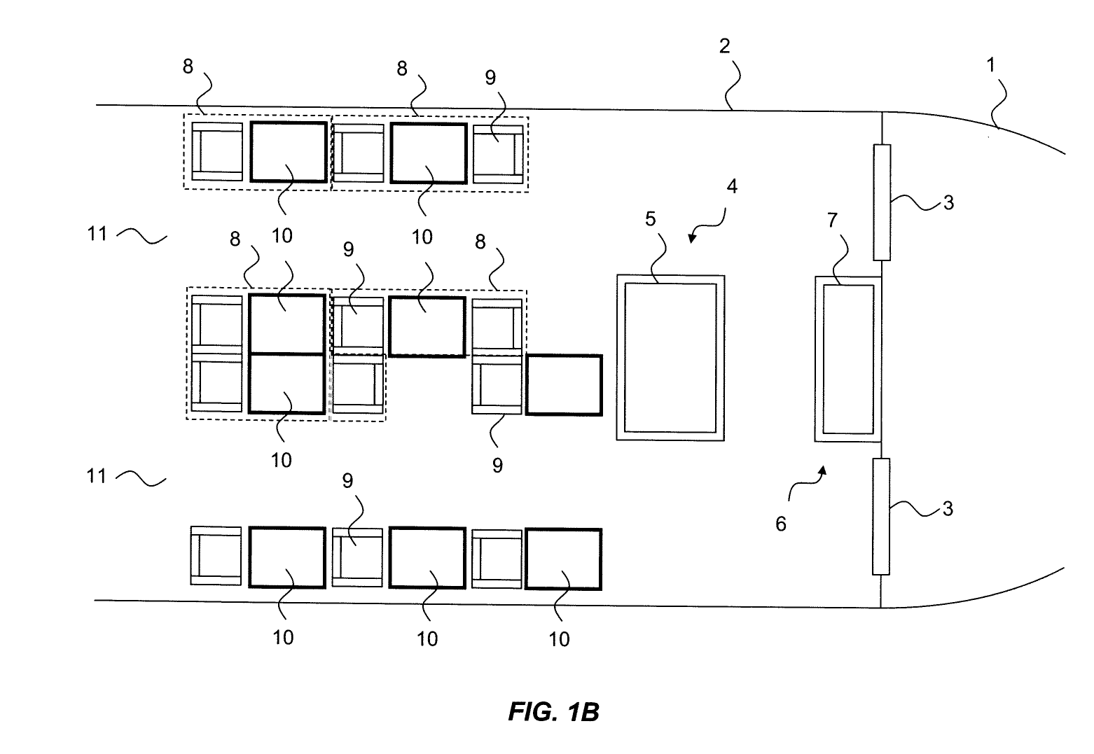

FIG. 1A shows the floor plan of an aircraft, in which a gastronomy section according to the invention is set up, and the seat configuration is typical of a first class layout. The aircraft encompasses a cockpit 1 and a section 2 for airline passengers. The airline passengers pass through outer doors (not shown) of the aircraft and into the vestibule of the aircraft cabin of the aircraft, which in the case depicted is the front section of the aircraft, and not shown separately from the actual cockpit. As obvious to the expert, the structure shown can also be located in the rear of the aircraft. From the front area on FIG. 1, the airline passengers open through doors 3 and step into the actual section 2. Kitchen units that are covered by curtains or the like as the airline passengers enter and exit are usually situated at the height of the through doors 3.

Once in section 2, the airline passengers assume their spots in seat groups 8 provided for this purpose, which comprise several seats 9 that are directly adjacent or functionally associated in some other way. The individual seats are turned in the flight direction, as depicted on FIG. 1A. FIG. 1B shows a seat configuration that is assumed during flight. The transition between the configuration on FIG. 1A and FIG. 1B can take place at any point desired by simply turning the individual seats 9 around their vertical axis, so that the passengers are seated looking back instead of ahead.

The seat groups 8 are shown in the traveling position on FIG. 1B. In the traveling position, the seats 9 are turned in such a way as they are to be aligned over a longer period of time, i.e., at least several seats are turned toward the back. In addition, the seat groups 8 are enhanced by tables 10, which serve as a place to put objects of any kind, and in particular as an area to consume meals. The individual seats 9 can be combined into any seat groups 8 desired, i.e., the seat groups 8 must not just encompass directly opposed or adjacent individual seats 9, but can also encompass other individual seats in the vicinity. The table 10 is located between two seats of a seat group 8.

In the embodiment of the section shown on FIG. 1A and 1B, three rows of seat groups 8 with two aisles 11 between them are situated in the section 2. It is basically conceivable to incorporate only two rows with seat groups 8 in the section 2, wherein these would then only be separated from each other by one aisle 11. The expert is fully aware that the outer dimensions of the aircraft and dimensions of the seat groups determine the arrangement of seat groups 8 and division of the section 2.

In addition to the so-called seat groups, a cooking island 4 is provided in the section 2 according to the invention. The cooking island 4 generally encompasses a heating unit, e.g., a steam slow cooker, a microwave oven or a cool top platform. In the embodiment according to FIG. 1A and 1B, the cooking island 4 consists of at least a cool top platform 5. Meals previously prepared in a preparation element 6 can be cooked and presented on this cool top platform 5. The preparation element here encompasses a corresponding storage area, in which preliminary products can be kept and presented. The fresh preliminary products are prepared in front of the passenger, and processed into intermediate products. The meals are then freshly cooked from the intermediate products. As a result, the airline passenger can see the preparation quality with his own eyes, giving the passenger a gastronomic event that contributes to entertainment onboard the aircraft, by contrast to previous flight operations.

After the meals are prepared, they are heated or kept at a predetermined temperature on the cool top platform or stove surface 5. As an alternative, they can also be processed in an oven (not shown) or the like of the cooking island 4. To enable them to serve themselves the meals on the cool top platform 5, the passengers can access the cooking island 4 from at least one side. The meals can then be presented on it buffet-style of course, the passengers can also be served by the flight personnel from this buffet.

In order to satisfy the safety requirements on board an aircraft, the cooking island 4 has one or more cooking and heating surfaces permitted by aviation technology. These are preferably glass ceramic surfaces with one or more cooking surfaces, wherein each cooking surface encompasses an induction or halogen heating unit.

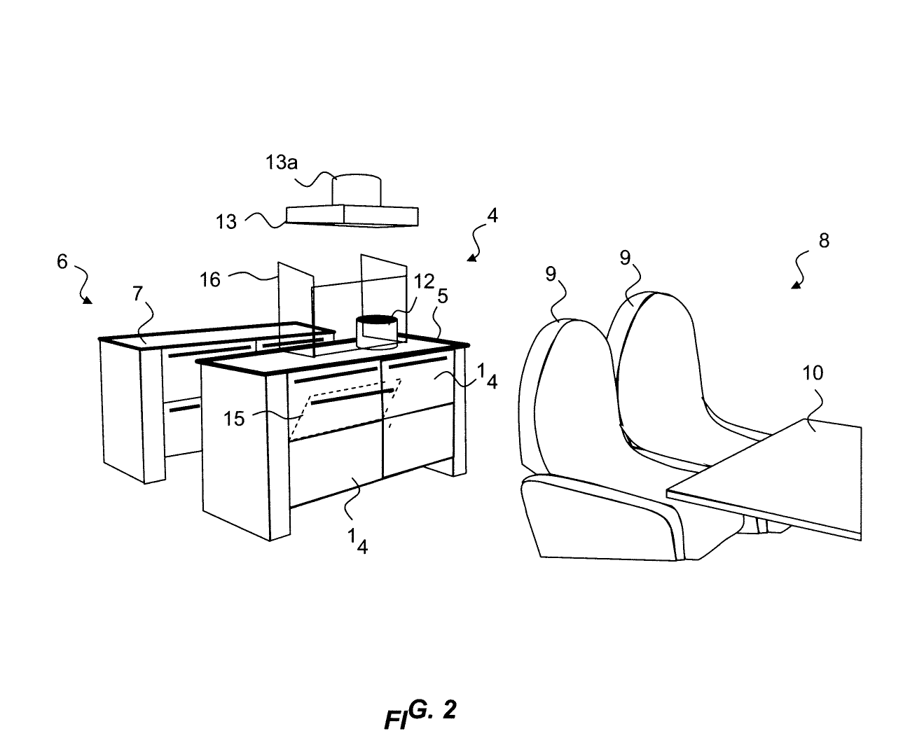

FIG. 2 shows a perspective view of the embodiment according to FIG. 1. Shown in the background of FIG. 2 is the preparation element 6 with the working area 7, which preferably encompasses a working or preparation surface. In particular, the preparation element 6 can also be designed as a cabinet element without preparation surface for storing preparation devices or preliminary meal products. Preliminary products located in the storage areas denoted under the surface 7 can be prepared on this working surface 7. The intermediate products can be cooked and presented on the cool top platform 5 of the cooking island, for example in preparation containers 12. To eliminate odors and splash, a closed hood 13 is provided over the cool top platform 5, which is preferably connected by a vent canal 13a with a filter system (not shown) for cleaning the air, or with the outside air. In addition, a detachable splashguard 16 can be provided, here depicted as a transparent wall, e.g., glass or Plexiglas. However, it is also conceivable to generate a stream of air around the cool top platform that exerts an effect similar to a wall made out of solid material. The air stream for shielding the cool top platform 5 away from the area with the seat groups 8 can be generated in particular by blower or exhaust nozzles (not shown). This ensures that the passengers in the seat groups 8, of which the right one is shown on FIG. 2, can observe first hand how the meals are prepared, without being disturbed by emissions from the cool top platform 5. In the embodiment depicted, the seat groups 8 in turn encompass several seats 9, e.g., arranged around a table 10.

Latching means (not shown) are preferably also provided for holding the preparation containers 12, thereby precluding any uncontrolled movements in the event of unforeseen flight motions. These latching means encompass mechanical brackets in particular.

Several self-serve compartments 14 are located under the cool top platform 5 of the cooking island. These self-serve compartments 14 can offer additional meals that are to be kept either at a higher or lower temperature in comparison to the ambient temperature in the section 2. To simplify the choice of meals for the passenger, the self-serve compartments 14 are preferably accessible to the passengers via a transparent door 15, one of which is shown in a partially opened state. The self-serve compartments 14 are preferably also accessible from the back, so that personnel can refill them again from the back. The ability to load compartments can of course be expanded to the compartments in the preparation element 6, which can in particular be loaded by personnel behind the separating wall between the cockpit 1 and gastronomy section 2., i.e., unseen by passengers in the section 2. To repeat, the passengers can serve themselves, but just as easily be served by the accompanying flight personnel where they are seated.

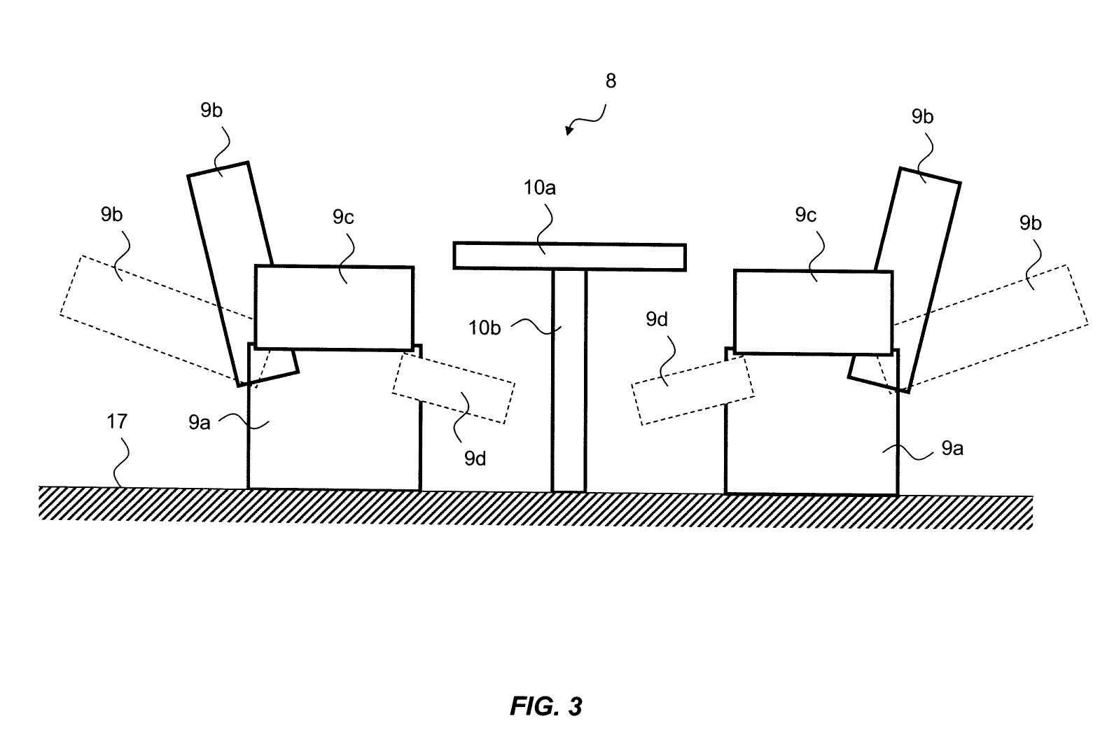

FIG. 3 shows a seat group 8 of the section according to the invention from the side. The seats 9 consist of a seat frame 9a to which a seat back 9b is secured. In the embodiment shown, this seat back 9b can be swiveled around its shared axis with the seat frame, so that the seat 9 can be reconfigured to act as a recliner. In the representation the seats in their normal position are depicted in bold lines, in their recliner position they are depicted in dashed lines. The sides of the seat 9 are flanked by an armrest 9c, and a pivoting footrest 9d is secured at the bottom end that supports the legs of the passenger when the backrest 9b is in the reclined position. The two seats 9 can preferably be adjusted relative to each other, so that they can be moved toward or away from each other. Further, they can preferably be rotated around a vertical axis (not shown), so that the passengers can all look in one direction during the takeoff and landing of the aircraft, preferably toward the cockpit 1.

In addition, the seats can also be arranged “in gaps”, so that the seats 9 are not directly opposite each other, but laterally offset. The advantage to this is that it produces a greater legroom for the passengers. This is achieved in a preferred embodiment (not shown) by turning the seats in their respective location around their vertical axis by a small angle, wherein the angle relative to the opposing seats alternates between positive and negative.

The table 10 consists of two parts, the table plate 10a and table leg 10b. Of course, the expert understands that other table configurations are conceivable, in which several table legs hold the table plate, for example. The table plate 10a and table leg 10b can be detachably connected. As a result, the table can be dismantled, and hence taken apart completely, or lowered into the floor 17 of the section 2.

In a preferred embodiment of the invention (not shown), the seat groups 8 in the gastronomy section 2 are arranged in a semicircle around the cooking island 4, so that they enclose an angle of 180°. This divides up the space within the gastronomy section like a theater.

The invention is not limited to the embodiments presented. In particular, for example, the cooking island 4 is height adjustable, so as to alter the viewing angle on the cool top platform 5, or make the self-serve compartments 14 more or less accessible.

### REFERENCE LIST

1 Aircraft, cockpit
2 Aircraft, gastronomy section
3 Passage door between the cockpit and gastronomy section
4 Cooking island
5 Cool top platform
6 Preparation element with stowage area
7 Working area or surface
8 Seat group
9 Seat, 9a seat frame, 9b backrest, 9c armrest, 9d foot-rest
10 Table, 10a table plate, 10b table leg
11 Aisle
12 Preparation container
13 Closed hood, 13a vent canal
14 Self-serve compartment
15 Transparent door of self-serve compartment
16 Splashguard
17 Floor gastronomy section

1. A gastronomy section for a transport means for conveying passengers, in particular an aircraft, comprising:
at least one preparation element (6) with stowage area for storing and/or presenting preliminary products,
at least one working area (7) for preparing intermediate products from the preliminary products,
at least one heating unit for preparing meals from the intermediate products, and
several seat groups (8) for passengers,
wherein
the at least one heating unit is comprised of at least one cooking island (4) accessible for passengers from at least one side, so that the meals can be presented there as a kind of buffet.

2. The gastronomy section according to claim 1, wherein several self-serve compartments (14) are arranged next to and/or under the at least one heating unit.

3. The gastronomy section according to claim 1, wherein the several self-serve compartments (14) can be heated, cooled or kept at a prescribed temperature.

4. The gastronomy section according to claim 1, wherein the several self-serve compartments (14) have transparent doors (15).

5. The gastronomy section according to claim 1, wherein the several self-serve compartments (14) are accessible from their respective front and rear sides.

6. The gastronomy section according to claim 1, wherein the cooking island (4) has a glass ceramic surface with one or more cooking surfaces, wherein each cooking surface encompasses an inductive or halogen heating element.

7. The gastronomy section according to claim 1, wherein one closed hood (13, 13a) is situated over the cooking island (4) and/or several exhaust vents are arranged at the edge of the cooking island (4).

8. The gastronomy section according to claim 1, wherein the cooking island (4) has a detachable splashguard (16) that extends around the cooking surface, and has a glass wall or Plexiglas wall.

9. The gastronomy section according to claim 1, wherein the cooking island (4) has means for holding preparation containers (12) in place, which in particular consist of brackets.

10. The gastronomy section according to claim 1, wherein the cooking island (4) is height-adjustable.

11. The gastronomy section according to claim 1, wherein the seat groups (8) in the gastronomy section are arranged in an at least 180° semicircle around the cooking island (4).

12. The gastronomy section according to claim 1, wherein each of the seat groups (8) encompasses at least two seats (9) facing each other, as well as a table (10) between the two seats (9).

13. The gastronomy section according to claim 1, wherein the table (10) can be dismantled and/or lowered into the floor (17) of the gastronomy section.

14. The gastronomy section according to claim 12, wherein each seat (9) of a seat group (8) can be rotated around a vertical axis, so that the seat groups can be configured at a predetermined time.
